(19) United States
(12) Patent Application Publication
(10) Pub. No.: US 2015/0224596 A1
(43) Pub. Date: Aug. 13, 2015

(54) PORTABLE BEAM DELIVERY SYSTEM

(71) Applicant: Delta Industrial Services, Inc., Minneapolis, MN (US)

(72) Inventor: David Schiebout, Brainerd, MN (US)

(21) Appl. No.: 14/176,799

(22) Filed: Feb. 10, 2014

(51) Int. Cl. B23K 26/00; B23K 26/08; B23K 26/14; B23K 26/30; B23K 26/06

(52) U.S. Cl. CPC B23K 26/0096; B23K 26/423; B23K 26/0626; B23K 26/1405; B23K 26/0869

(57) ABSTRACT

This document discusses, among other things, methods and apparatus for a portable beam delivery system. In an example, an apparatus can include an enclosure including wheels, the enclosure configured to be moved about using the wheels, a laser system having a movable portion mounted to an outside surface of the enclosure, the moveable portion configured to provide a laser beam to a location determined by a position of the moveable portion and a position of the enclosure, and a controller enclosed within the enclosure, the controller configured to modulate an energy level of the laser beam.

### TECHNICAL FIELD

This application relates generally to automated web processing systems, and more particularly, to methods and apparatus for a portable beam delivery for automated web processing systems.

### BACKGROUND

There are various automated systems and methods for producing product. By way of example, automated web converting systems may process material from different rolls of material to form product. The continuous rolls of material are fed as “webs” through web processing components to form a new product that may be an intermediate or final product. Converting processes may include coating, laminating, printing, die cutting, slitting, and the like. Some converting equipment can offer flexible configurations that can easily change the sequence of converting operations such as die cutting and slitting. However, some converting operations, such as converting operations that make use of a laser, are very inflexible once such operation are installed on a converting machine.

### SUMMARY

This document discusses, among other things, methods and apparatus for a portable beam delivery system. In an example, an apparatus can include an enclosure including wheels, the enclosure configured to be moved about using the wheels, a laser system having a movable portion mounted to an outside surface of the enclosure, the moveable portion configured to provide a laser beam to a location determined by a position of the moveable portion and a position of the enclosure, and a controller enclosed within the enclosure, the controller configured to modulate an energy level of the laser beam.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIGS. 1A-1D illustrate generally examples of portable beam delivery systems.

FIG. 2 illustrates generally an example exhaust system for an example portable beam delivery system.

FIG. 3 illustrates generally an example portable beam delivery system in position for delivering beam operations with web running on an adjacent converting machine.

FIG. 4 illustrates generally a flowchart of an example method of using a portable beam delivery system.

### DETAILED DESCRIPTION

The present inventor has recognized a portable packaged system for delivering a beam, such as a laser beam, for production purposes. The system is capable of operating in multiple processing modes, thus allowing a user to adapt the beam delivery system to more than one product and, in certain examples, because the system is portable, to more than one production line or production area. In certain examples, even when the system has been positioned, the beam can be delivered to more than one location.

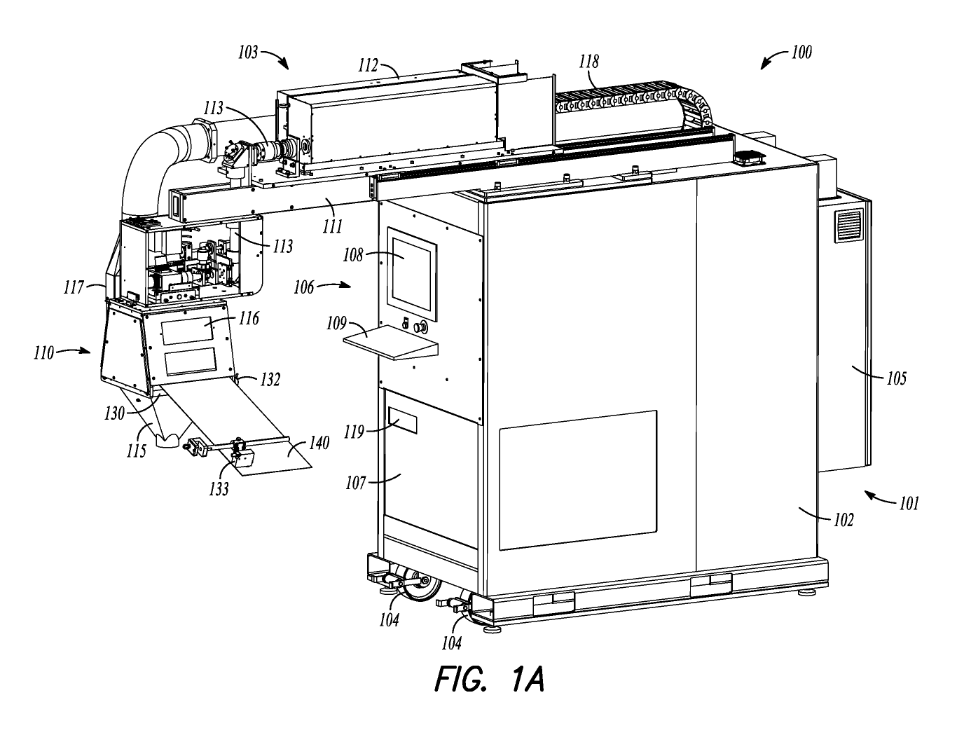

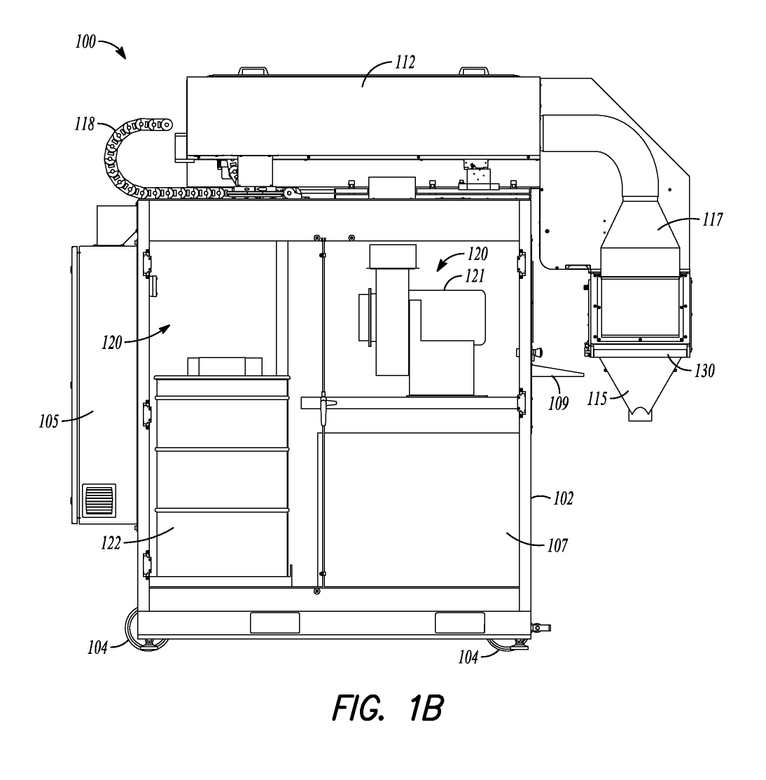

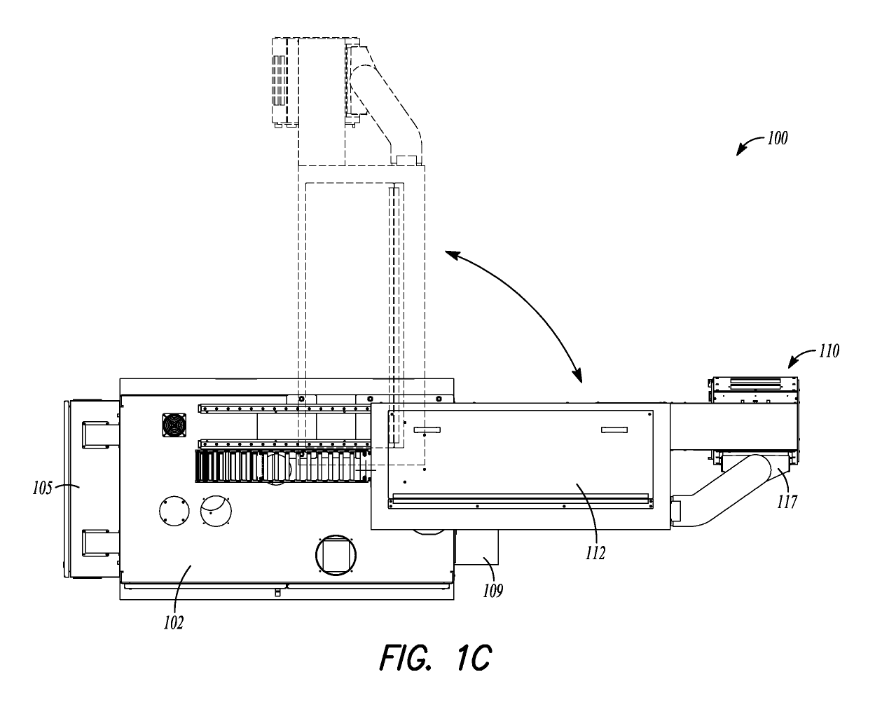

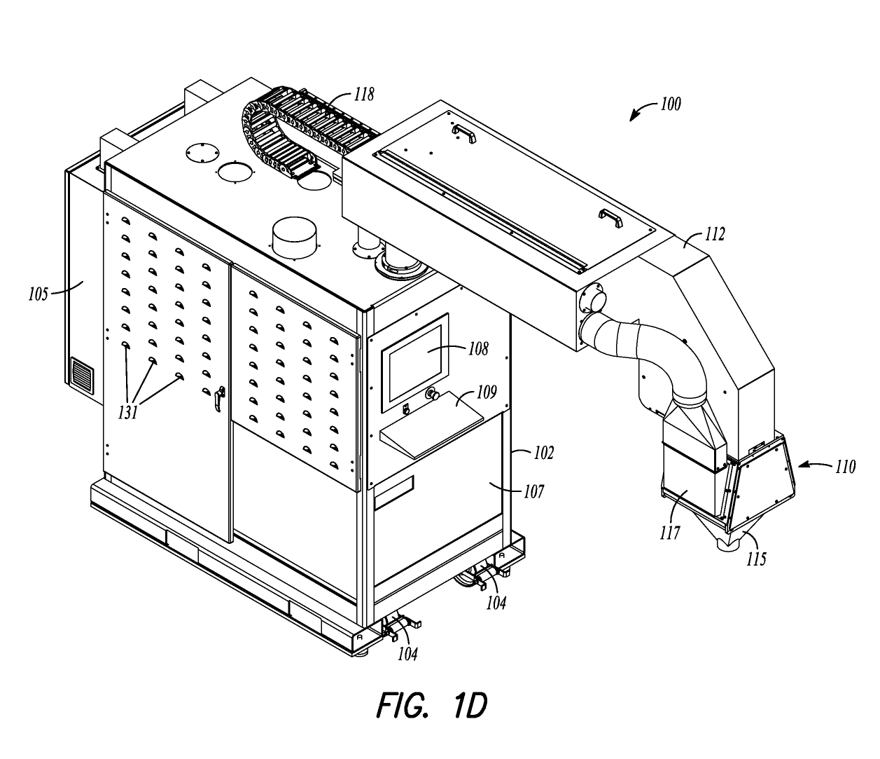

FIG. 1 illustrates generally an example portable beam delivery system 100. In certain examples, the portable beam delivery system 100 can include a portable support structure 101 and a moveable portion 103 coupled to the portable support system 101. In certain examples, the portable support structure 101 can include wheels 104 for moving the beam delivery system 100 about a plant floor. In some examples, the wheels 104 can be locked in position to prevent the portable beam delivery system 100 from rolling. In some examples, the wheels 104 can be retracted to prevent the portable beam delivery system 100 from rolling.

In certain examples, the portable support structure 101 can include a main enclosure 102 for housing support equipment such as a chiller 107, an exhaust system (not shown), or combination thereof. In some examples, the portable support structure 101 can include an electrical enclosure 105 for housing control and electrical distribution components. In some examples, the portable support structure 101 can include an open frame instead of a main enclosure 102 to support the moveable portion 103 and to contain other components of the portable beam delivery system 100, such as those components discussed below with regards to the main enclosure 102. In certain examples, the open frame can include doors or panels to enclose some of the accessory components of the portable beam delivery system. In some examples, the moveable portion of the portable beam delivery system can be mounted to surfaces of an open frame support structure, such as external surfaces of an open frame support structure. In certain examples, the portable support structure 101 can include an enclosure to support the moveable portion 103 and the enclosure does not include a frame for supporting the moveable portion 103.

In certain examples, the main enclosure 102 can include an operator interface area 106 for mounting a display 108, such as a touch screen. In some examples, the operator interface area 106 can include buttons, dials, and or switches for controlling or monitoring the beam delivery system In some examples, the main enclosure 102 can include a keyboard tray 109 for holding a keyboard that can be used to provide input information for controlling or monitoring the portable beam delivery system 100.

In certain examples, the moveable portion 103 of the beam delivery system can be mounted to an outside surface of the main enclosure 102, such as the top of the main enclosure 102. In some examples, the moveable portion 103 can be mounted to a side of the main enclosure 102. In certain examples, the moveable portion 103 of the beam delivery system can include beam delivery hood 110, a motion system 111 for positioning the beam delivery hood 110, a beam generator 112, such as a laser, and beam delivery optics 113 for providing an optical path from the beam generator 112 to the beam delivery hood 110.

In certain examples, the motion system 111 can include a rotary motion system to position the beam delivery hood 110. FIG. 1C illustrates generally an example portable beam delivery system having a rotary motion system to position the beam delivery hood 110. As shown in FIG. 1A, in certain examples, the motion system 111 can include a cantilevered, linear motion system for extending and retracting the beam delivery hood 110 away from and toward the main enclosure 102. FIG. 1B illustrates generally an example portable beam delivery system with the motion system 111 in an example retracted position. In some examples, the extended position of the linear motion system 111 can create a walkway, pathway or operator area 114 between the main enclosure 102 and the beam delivery hood 110. In certain examples, the extended position can be set up as an “online” position of the portable beam delivery system 100 and the retracted position can be setup as an “offline” position of the portable beam delivery system 100. In the “online” position, the portable beam delivery system 100 can integrate with and can perform production operations in coordination with a larger production line such as a converting line, a web line or a printing line, for example. In the “offline” position, the portable beam delivery system 100 can be used for test runs and experimentation. In certain examples, the retracted position can be set up as a second “online” position and can be used to integrate and perform production operations with a second production line. In certain examples, the extended position can be used as an “offline” position. In some examples, the retracted position provides an optimal position for efficiently preparing and safely shipping the portable beam delivery system 100 with minimal disassembly preparation.

In certain examples, the moveable portion 103 can be moved and set in position manually. In such examples, a clamp or manual brake can be engaged to hold the moveable portion 103 at a desired position. In certain examples, the moveable portion 103 can include an actuator to move and position the moveable portion 103. Such actuators can include, but are not limited to, a servo actuator, a pneumatic actuator or cylinder, a hydraulic actuator, a motor driven actuator, or a combination thereof.

In certain examples, the moveable portion 103 can include a laser 112, or laser system, for generating the beam. In certain examples, the laser system 112 can be sized and shaped to accommodate a variety of laser types and power ratings. In some examples, the portable beam delivery system 100 can be sized for 300-2000 W, 9.4 μm or 10.6 μm wavelength lasers. However, it is understood that other laser types and power rated lasers are possible for use with the portable beam delivery system 100 without departing from the scope of the present subject matter. In general, having the laser 112 as close to the processing area where the beam interfaces with the production materials can provide the best processing performance and efficiency. However, the laser 112 can be quite bulky and having the laser located close to the beam/production material interface 115 can eliminate options for using the laser 112 for other production purposes. In contrast, having the laser 112 located on the moveable portion 103 can provide a relatively short optical path from the laser 112 to the beam/production material interface 115 while at the same time allowing the location of the beam delivery to be moved about relatively easily, quickly, and efficiently.

The beam delivery hood 110 can protect the beam path from interference at and near the beam/production material interface. In certain examples, the beam delivery hood 110 can include one or more transparent panels 116 to allow an operator to observe and monitor the operation of the portable beam delivery system 100 at and near the beam/production material interface. In certain examples, the beam delivery hood 110 can include hood duct 117 to allow fumes and waste material to be removed from the beam/production material interface area. In certain examples, the beam delivery hood 110 can enclose and protect at least a portion of the beam delivery optics 113. In some examples, the beam delivery optics 113 can include a dynamic focusing module (DFM) to adjust the field of view of the portable beam delivery system 100. In certain examples, the DFM can allow the spot size of the beam to be adjusted. In some examples, the DFM can allow a cutting depth of the beam to be adjusted.

In certain examples, one or more idler rolls 130 can be integrated with the beam delivery hood. The idler rolls 130 can assist in moving production materials along a web path that interfaces with the delivered beam within the beam delivery hood 110. In certain examples, auxiliary duct 115 can be integrated with the beam delivery hood 110 to provide a source of vacuum underneath the production materials relative to the beam delivery optics 113.

In certain examples, the main enclosure 102 can house a chiller 107 for providing cooling to the beam generator 112. In certain examples, such as for a linear motion system, a flexible wire way 118 can provide protection and guidance for chiller cooling hoses and control wiring coupling the chiller 107 with the beam generator 112 housed in the moveable portion 103. In certain examples, the chiller 107 can be positioned in the main enclosure 102 such that a display 119 of the chiller 107 can be monitored from a position external to the main enclosure 102. In certain examples, the main enclosure 102 can house a portion of an exhaust system 120. In certain examples, the exhaust system 120 can be used to remove fumes, smoke or gases produced as a result of interaction between the delivered beam and the production materials.

FIG. 1B also illustrates generally an example portable beam delivery system 100 with one or more doors of the main enclosure 102 removed to expose a chiller 107 and portions 121, 122 of an exhaust system 120.

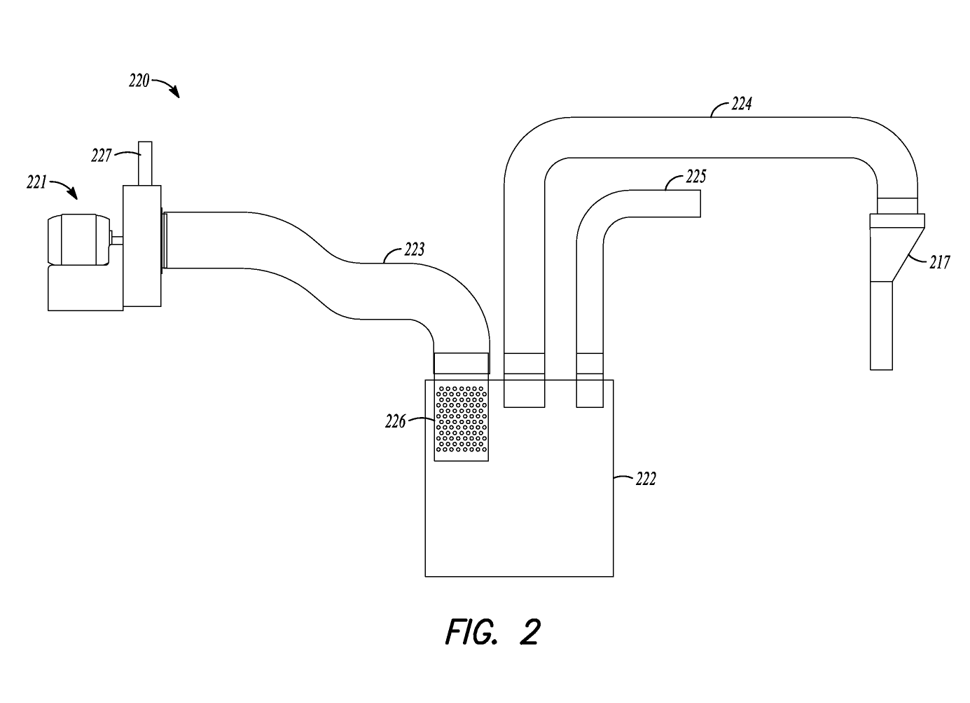

FIG. 2 illustrates generally an example exhaust system 220 for an example portable beam delivery system, such as the example portable beam delivery systems 100 of FIGS. 1A-1C. In certain examples, the exhaust system 220 can be used to remove waste production materials generated at or near the beam processing area. In certain examples, the exhaust system 220 can be used to remove waste production materials delivered to the beam processing area such as by production materials being conveyed via a web line, a converting line, or a printing line, for example. In some examples, the exhaust system 220 can be used to remove fumes, or fumes and waste production material. In certain examples, the exhaust system 220 can include a vacuum pump 221, such as a vacuum pump powered by a motor, a waste collection device 222, and duct 223, 224, 225 to provide vacuum to desired areas and to convey waste materials to the waste collection device 222. In certain examples, the vacuum pump 221 can provide vacuum to the waste collection device 222 through first duct 223 and a filter 226 and can exhaust pumped air or gases through an exhaust vent 227. As the air and gases move from machine duct 224, 225 through the waste collection device 222, the filter 226 can capture waste product in the waste collection device 222.

In certain examples, at least a portion of the machine duct 224 can be coupled to hood duct 217 to provide vacuum at the beam delivery hood. In some examples, at least a portion of the machine duct can include auxiliary duct 225 to provide vacuum at other locations near the location of the portable beam delivery system. In some applications, production materials at and near the beam/production material interface are supported by idler rolls, a plate, or a table. In certain examples, auxiliary duct 225 can provide vacuum to a location underneath the production materials. In some applications, the beam delivery hood can include idler rolls for conveying a web of production material through the beam delivery hood and auxiliary duct 225 can be integrated with the beam delivery hood to direct fumes and waste material below the web. In certain applications, providing vacuum beneath the production materials can assist in operating the beam more efficiently as such vacuum can direct fumes and smoke away from the optical path of the beam and thus ameliorate such smoke and fumes from interfering with or attenuating the beam path.

In certain applications, a portable beam delivery system including an exhaust system can provide multiple benefits to a plant operator. Such benefits can include, but are not limited to, eliminating the cost of a permanent exhaust system, eliminating the cost associated with providing exhaust to beam processing areas not currently serviced with an exhaust system, and eliminating safety concerns associated with temporarily providing exhaust to temporary beam processing areas.

FIG. 1D illustrates generally an alternative view of an example portable beam delivery system. In certain examples, the main enclosure 102 can includes louvers 131, such as louvers 131 located on doors of the main enclosure 102, to assure that the interior air pressure of the main enclosures is approximate equal to the external air pressure of the main enclosure. Substantial pressure differences between the internal and external air pressure of the main enclosure can cause unexpected motion of the enclosure doors when the door latches are released.

Referring again to FIG. 1A, in certain examples, a control system for a portable beam delivery system 100 can include a speed input, a position input, or a combination of a speed and position input such as an encoder or resolver input. In some examples, the speed or position input can be coupled to a speed or position sensor, such as an encoder 132 or a resolver, to provide speed or position information of process material to the controller of the portable beam delivery system 100. In some examples, the speed or position information can be used to enable or disable the beam. In some examples, the speed or position information can be used to modulate one or more parameters of the beam generator 112 such as beam intensity, beam power, or beam energy, for example. In some examples, the speed or position information can be used to control a parameter of the chiller 107. In some examples, the speed or position information can be used to control a parameter of the vacuum system 120 such as pump speed or a position of a vacuum control valve. In certain examples, an encoder 132 can be mounted to an idler roll, such as an idler roll 130 integrated with the beam delivery hood 110 to provide speed information of a web material 140 passing over the idler roll 130. In certain examples, encoder wiring can use the flexible wireway 118 to couple the encoder 132 to the controller, such as a controller housed in the electrical enclosure 105.

Referring again to FIG. 1A, in certain examples, a control system for a portable beam delivery system 100 can include a registration input. In some examples, registration input can be coupled to a registration sensor 133 to provide registration information of process or web material 140 to the controller of the portable beam delivery system 100. In some examples, the registration information can be used to enable and disable the beam such that beam operations are registered to other landmarks of the process, production or web material 140.

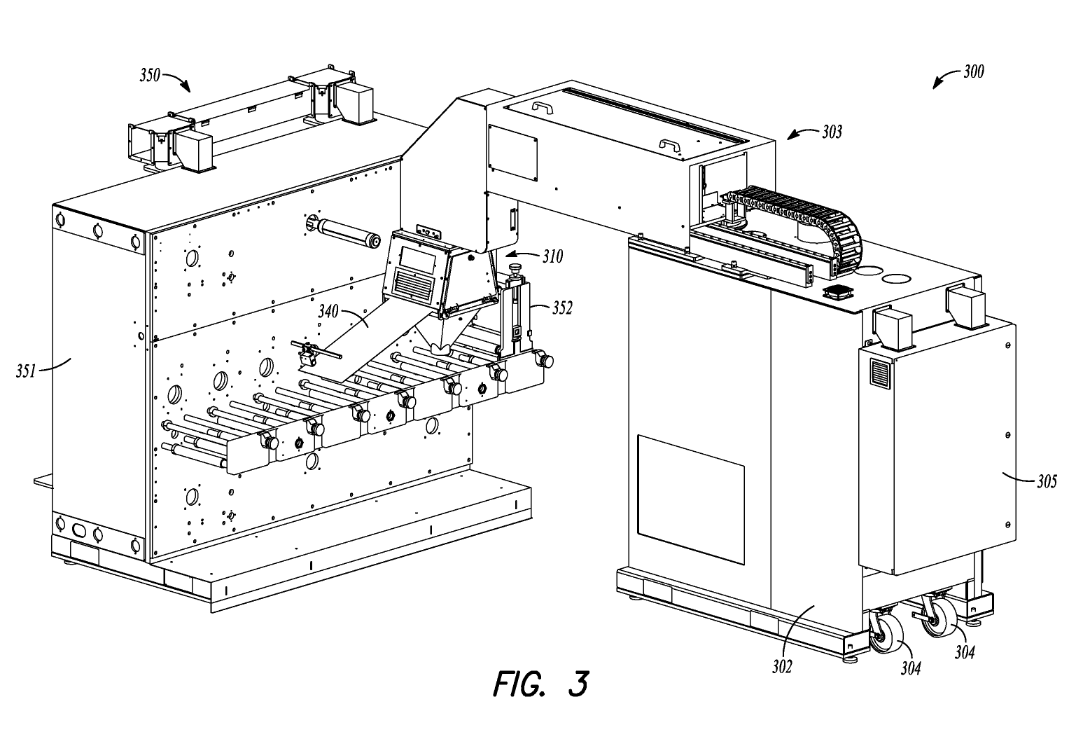

FIG. 3 illustrates generally an example portable beam delivery system 300 in position for delivering beam operations with web running on an adjacent converting machine 350. The converting machine 350 includes a configurable base module 351 with one or more modular stands 352 removed to expose how the web 340 can interface with the portable beam delivery system 300. In certain examples, the portable beam delivery system 300 can include a main enclosure 302, an electrical enclosure 305, a moveable portion 303, and a beam delivery hood 310 with integrated idler rolls as described above with reference to the examples of FIGS. 1A-1D. The portable beam delivery system 300 is shown in FIG. 3 with the a linear moveable portion 303 extended to provide beam processing at the converting machine 350. If desired, the moveable portion 303 can be retracted to bring the beam delivery hood 310 closer to the main enclosure 302 to provide beam processing for a different application. If desired, the portable beam delivery system 300 can be moved, using wheels 304 attached to the main enclosure 302, to a different location to provide beam processing for one or more other operations.

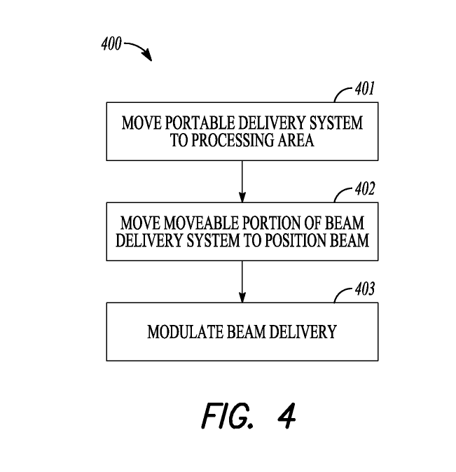

FIG. 4 illustrates generally a flowchart of an example method 400 of using a portable beam delivery system. In certain examples, at 401, the method can include using wheels mounted to an enclosure of the portable beam delivery system to move the portable beam delivery system to a processing area such as a web processing area or a workbench area. At 402, a moveable portion of the portable beam delivery system can be used to present a laser beam to a location within the processing area. At 403, the laser beam can be modulated to process materials using a controller housed in the enclosure. In certain examples, a vacuum system can evacuate fumes and waste material from the processing area as the laser beam is operating. In some examples, a cooling system can be used to cool the laser providing the laser beam. In some examples, the moveable portion can be moved to provide the beam at a second position such as a second web processing area or a second work bench area. The certain examples, modulating the beam can include using speed information received from an encoder mounted to a web processing line associated with the processing area. As discussed above, in some examples, the speed sensor can be mounted to a idler associated with a beam delivery hood of the portable beam delivery system. In some examples, modulating the beam can include using registration information received from a registration sensor associated with the material being processed by the laser beam.

The methods illustrated in this disclosure are not intended to be exclusive of other methods within the scope of the present subject matter. Those of ordinary skill in the art will understand, upon reading and comprehending this disclosure, other methods within the scope of the present subject matter. The above-identified embodiments, and portions of the illustrated embodiments, are not necessarily mutually exclusive. These embodiments, or portions thereof, can be combined. In various embodiments, the methods are implemented using a sequence of instructions which, when executed by one or more processors, cause the processor(s) to perform the respective method. In various embodiments, the methods are implemented as a set of instructions contained on a computer-accessible medium such as a magnetic medium, an electronic medium, or an optical medium.

The above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

What is claimed is:

1. An apparatus comprising:
a support structure including wheels, the apparatus configured to be moved about using the wheels;
a laser system having a movable portion mounted to the support structure, the moveable portion configured to provide a laser beam to a location determined by a position of the moveable portion and a position of the support structure; and
a controller contained within a portion of the support structure, the controller configured to modulate an energy level of the laser beam.

2. The apparatus of claim 1, wherein the support structure includes an enclosure configured to enclose the controller.

3. The apparatus of claim 2, including a chiller system, at least a portion of the chiller system housed within the enclosure, the chiller system configured to provide cooling for the laser system.

4. The apparatus of claim 2, including a collection system, at least a portion of the collector system housed within the enclosure, the collection system configured to evacuate air from an area near the location determined by the position of the moveable portion and the position of the enclosure.

5. The apparatus of claim 4, wherein the collection system includes duct configured to move with the moveable portion.

6. The apparatus of claim 4, wherein the collection system includes a vacuum pump housed in the enclosure.

7. The apparatus of claim 2, wherein the moveable portion includes a linear motion system having a first operating position and a second operating position, the first operating position configured to provide the location adjacent the support structure and a second operating position configured to provide a pathway between the location and the enclosure.

8. The apparatus of claim 2, wherein the moveable portion includes a rotary motion system having a first operating position located perpendicular to a first exterior side of the enclosure and a second operating position located perpendicular to a second exterior side of the enclosure, wherein the first and second exterior sides are the closest sides of the enclosure to the location when the moveable portion is in the respective first or second operating position.

9. The apparatus of claim 1, wherein the moveable portion includes a pneumatic cylinder to move the moveable portion between a first operating position and a second operating position.

10. The apparatus of claim 1, wherein the moveable portion includes a servo motor to move the moveable portion between a first operating position and a second operating position, and
wherein the controller is configured to control the servo motor.

11. The apparatus of claim 1, including a speed input configured to receive speed information of an associated machine; and
wherein the controller is configured to control the laser system using the speed information.

12. The apparatus of claim 11, including a registration input configured to receive registration information associated with product moving toward the location; and
wherein the controller is configured to control the laser system using the registration information.

13. A method processing material, the method comprising:
moving an portable support system to a processing area using wheels coupled to the portable support system;
positioning a moveable portion of a laser system to a first location determined by a location of the portable support system within the processing area and a location of the moveable portion, the moveable portion attached to an exterior surface of the portable support system; and
modulating an energy level of the laser system using a controller housed in the enclosure.

14. The method of claim 13, including cooling the laser system using a chiller housed in the portable support system.

15. The method of claim 13, including evacuating air from an area near the location determined by the position of the moveable portion and the position of the portable support system; and
collecting residue evacuated from the location in a portion of the collection system housed within the portable support system.

16. The method of claim 13, wherein positioning the moveable portion of the laser system includes linearly moving the moveable portion of the laser system between a first operating position and a second operating position using a linear motion system.

17. The method of claim 13, wherein positioning the moveable portion of the laser system includes rotating the moveable portion of the laser system between a first operating position and a second operating position using a rotary motion system.

18. The method of claim 13, wherein positioning the moveable portion of the laser system includes manually positioning the moveable portion of the laser system.

19. The method of claim 13, including receiving speed information about the material at the controller; and
wherein modulating an energy level of the laser system includes modulating an energy level of the laser system using the controller and the speed information.

20. The method of claim 19, including receiving registration information about the material at the controller; and
wherein modulating an energy level of the laser system includes modulating an energy level of the laser system using the controller and the registration information.
